(19) United States
(12) Patent Application Publication
(10) Pub. No.: US 2026/0085504 A1
(43) Pub. Date: Mar. 26, 2026

(54) MULTIFUNCTIONAL SHOWER DEVICE

(71) Applicant: Delux(Xiamen)Sanitary Ware Co.,Ltd, Xiamen (CN)

(72) Inventors: Wenyong NIU, Xiamen (CN); Wenjian WU, Xiamen (CN)

(73) Assignee: Delux(Xiamen)Sanitary Ware Co.,Ltd, Xiamen (CN)

(21) Appl. No.: 19/080,616

(22) Filed: Mar. 14, 2025

(30) Foreign Application Priority Data
Sep. 26, 2024 (CN) 2024113499882

(51) Int. Cl. E03C 1/04; E03C 1/02

(52) U.S. Cl. CPC E03C 1/0408; E03C 2001/026

(57) ABSTRACT

Provided is a multifunctional shower device, including a top shower and a fixed valve. The top shower has at least two water outlet modes, and includes at least two sets of top shower water outlet nozzles and top shower water inlet passages that are in communication in one-to-one correspondence. The fixed valve is provided with a water inlet connector, a switching assembly, water outlet passages, and a switching handle. The water outlet passages include at least three branches, including top shower water outlet passages and hand shower water outlet passages, and the water inlet connector is in communication with any water outlet passage by switching the switching assembly. The top shower is mounted to the fixed valve, and the top shower water outlet passages of the fixed valve are in communication with the top shower water inlet passages of the top shower in one-to-one correspondence.

### CROSS-REFERENCE TO RELATED APPLICATIONS

The application claims priority to Chinese patent application No. 2024113499882, filed on Sep. 26, 2024, the entire contents of which are incorporated herein by reference.

### TECHNICAL FIELD

The present disclosure relates to the technical field of kitchen and bathroom, and in particular, to a multifunctional shower device.

### BACKGROUND

There are two main ways to install a top shower, one is to install it by means of a shower rod, and the other is to suspend it from a water outlet pipe pre-embedded in the wall. The latter is popular in the European and American markets. When using a pre-embedded pipe to install a top shower, there is no need to drill holes in the wall to install a shower rod, thus avoiding damage to the wall. However, this installation method often results in limited functionality of the top shower with only one water outlet mode. Moreover, when the top shower is used in conjunction with a shower switch provided at the bottom of the top shower, the entire shower device can only achieve the switching from a top shower water outlet mode to a hand shower water outlet mode, or can discharge water from both the top shower and the hand shower at the same time. Thus, the traditional method of installing a shower device using a pre-embedded pipe has the disadvantage of limited water outlet modes, and there is a need for further improvement.

### SUMMARY

In order to solve the above technical problems, a shower device having more water outlet functions is provided.

A multifunctional shower device includes a top shower and a fixed valve.

The top shower has at least two water outlet modes, and correspondingly includes at least two sets of top shower water outlet nozzles and top shower water inlet passages that are in communication in one-to-one correspondence.

The fixed valve is provided with a water inlet connector, a switching assembly, a water outlet passage, and a switching handle, where the water outlet passage includes at least three branches, comprising top shower water outlet passages and hand shower water outlet passages having openings obliquely downward, and the water inlet connector communicates with any of the water outlet passages by the switching of the switching assembly, such that the shower device discharges water either from the top shower in any water outlet mode or from the hand shower; moreover, by selecting different switch settings as needed, the shower device can also discharge water from the top shower in different water outlet modes simultaneously, or can discharge water from both the top shower in any water outlet mode and the hand shower at the same time. For ease of operation, the switching handle is provided outside the fixed valve, and is connected to and controls the switching assembly.

The top shower is mounted to the fixed valve, and the top shower water outlet passages of the fixed valve are in communication with the top shower water inlet passages of the top shower in one-to-one correspondence. The water inlet connector of the fixed valve is connected to a water outlet end of a pre-embedded pipe in a wall in a butt joint mode, and the multifunctional shower device is suspended and mounted on the wall by means of the water inlet connector of the fixed valve, such that the entire shower device is supported by the water inlet connector of the fixed valve.

The shower device provided by the present disclosure utilizes a top shower having multiple water passages and a fixed valve having multiple water outlet passages. When in use, the fixed valve can be switched according to the needs of users, allowing the top shower installed by means of a pre-embedded pipe to have a water outlet switching function, thereby not only increasing water outlet options of the top shower, but also enhancing water outlet functions of the entire shower device. In addition, the switching control of the top shower is separated from the head of the top shower, avoiding the problem that the switching control assembly is positioned too high and difficult to reach.

Preferably, the fixed valve is provided with a mounting cavity that is in communication with the water inlet connector and the water outlet passages, and the switching assembly is mounted inside the mounting cavity.

Preferably, the top shower includes a mounting handle and a water outlet head, one end of the mounting handle is assembled with the fixed valve, and the water outlet head is pivotally mounted to the other end of the mounting handle, such that consumers can adjust the angle of the water outlet of the top shower according to their needs.

Preferably, the top shower water inlet passage includes a fixed section, a pivotal section, and a connecting section, where the fixed section is provided at a water outlet end of the mounting handle, the pivotal section is provided at a pivotal mounting portion of the water outlet head, and the connecting section is provided inside a pivotal shaft between the mounting handle and the water outlet head, where the pivotal shaft is provided with a water inlet and a water outlet, the connecting section is always in communication with a water outlet end of the fixed section by means of the water inlet, and the connecting section is always in communication a water inlet end of the pivotal section by means of the water outlet. Thus, the water passages between the mounting handle and the water outlet head are integrated with the pivotal shaft, avoiding the use of hoses that could affect the flexibility of pivotal movement and lead to the breakage of the hoses at a pivotal position.

Preferably, one of the water inlet and the water outlet is provided on the periphery of the pivotal shaft, the number of the water inlet or the water outlet is at least one, the at least one water inlet or water outlet is positioned on a same circumferential line of the periphery of the pivotal shaft; and the other of the water inlet and the water outlet is provided at an end portion of the pivotal shaft.

Preferably, the top shower water inlet passage, the top shower water outlet passage, and the pivotal shaft each may be provided in two sets to prevent the entire structure and the water passage structure from being overly complex and to optimize the structural layout. A mating slot is provided at the water outlet end of the mounting handle, a mating lug is formed at each of two ends of the mating slot, the mating lug is provided with a through shaft hole in communication with the mating slot, and the water outlet end of the fixed section extends into the mating lug and is in communication with the shaft hole. The pivotal mounting portion of the water outlet head forms a mating plug, and the water inlet end of the pivotal section forms openings at two ends of the mating plug. The mating plug is inserted into the mating slot, the pivotal shaft is inserted into the shaft hole by means of an outer portion of the mating lug, and an end portion of the pivotal shaft is inserted into the openings at the two ends of the mating plug. Thus, the mating plug is pivotally mounted in the mating slot by the restriction of the pivotal shaft.

Preferably, the top shower and the fixed valve share a same housing, or housings of the top shower and the fixed valve are fastened together by means of screws; and the top shower water outlet passages of the fixed valve form water outlet connectors in the mounting handle of the top shower, and are in communication with the top shower water inlet passages in one-to-one correspondence by means of hoses.

Preferably, in order to be better used in conjunction with a hand shower, a hand shower holder facing a user is provided at the bottom of the top shower, a hand shower is suspended on the hand shower holder, and the hand shower is in communication with the hand shower water outlet passages of the fixed valve by means of hoses.

Preferably, in order to enhance the convenience of fixing the hand shower and improve the product quality, the hand shower holder and the hand shower are fixed by means of magnetic attachment, where the hand shower holder is provided with a magnetic slot facing the user, a first magnetic member is provided at a central portion of the magnetic slot, and a buffer rubber ring is provided on a periphery of the magnetic slot. A magnetic protrusion is provided at the back of the hand shower, and a second magnetic member is provided inside or at an end portion of the magnetic protrusion. The hand shower is inserted into the magnetic slot by means of the magnetic protrusion and is suspended on the hand shower holder by means of magnetic attachment between the first magnetic member and the second magnetic member, and an outward end of the buffer rubber ring abuts against the back of the hand shower.

Preferably, in order to enrich the water outlet modes of the hand shower and further enhance the water outlet functions of the shower device, the hand shower is provided with a switch and has at least two water outlet modes, and correspondingly includes at least two sets of hand shower nozzles and hand shower water outlet passages that are in communication in one-to-one correspondence.

According to the above description of the present disclosure, the present disclosure has the following beneficial effects:

1. The shower device provided by the present disclosure utilizes a top shower having multiple water passages and a fixed valve having multiple water outlet passages. When in use, the fixed valve can be switched according to the needs of users, allowing the top shower installed by means of a pre-embedded pipe to have a water outlet switching function, thereby not only increasing water outlet options of the top shower, but also enhancing water outlet functions of the entire shower device. In addition, the switching control of the top shower is separated from the head of the top shower, avoiding the problem of the switching control assembly being mounting too high and difficult to reach.

2. The fixed valve is provided with a switching handle for easy operation.

3. The water outlet head of the top shower is pivotally mounted, allowing consumers to adjust the water outlet angle of the top shower according to needs.

4. The water passages between the mounting handle and the water outlet head are integrated with the pivotal shaft, avoiding the use of hoses that could affect the flexibility of pivotal movement and lead to the breakage of the hoses at a pivotal position.

5. The bottom of the top shower is provided with a hand shower holder facing the user, on which a hand shower can be suspended, such that the top shower can be better used in conjunction with the hand shower.

6. The hand shower holder and the hand shower are fixed by means of magnetic attachment, enhancing the convenience of fixing the hand shower and improving the product quality.

7. The hand shower is provided with a switch and has at least two water outlet modes, enriching the water outlet modes of the hand shower and further enhancing the water outlet functions of the shower device.

### BRIEF DESCRIPTION OF DRAWINGS

The accompanying drawings described herein are intended to provide further understanding of the present disclosure and constitute a part of the present disclosure. The exemplary embodiments of the present disclosure and their descriptions are intended for illustration purposes and do not constitute improper limitations on the present disclosure.

FIG. 1 is a first axial side view of a multifunctional shower device;

FIG. 2 is a second axial side view of a multifunctional shower device;

FIG. 3 is a front view of a multifunctional shower device;

FIG. 4 is a side view of a multifunctional shower device;

FIG. 5 is a first cross-sectional view of a multifunctional shower device, taken along line A-A in FIG. 3;

FIG. 6 is a second cross-sectional view of a multifunctional shower device, taken along line B-B in FIG. 4; and

FIG. 7 is a partially enlarged view of a multifunctional shower device, corresponding to section C in FIG. 6.

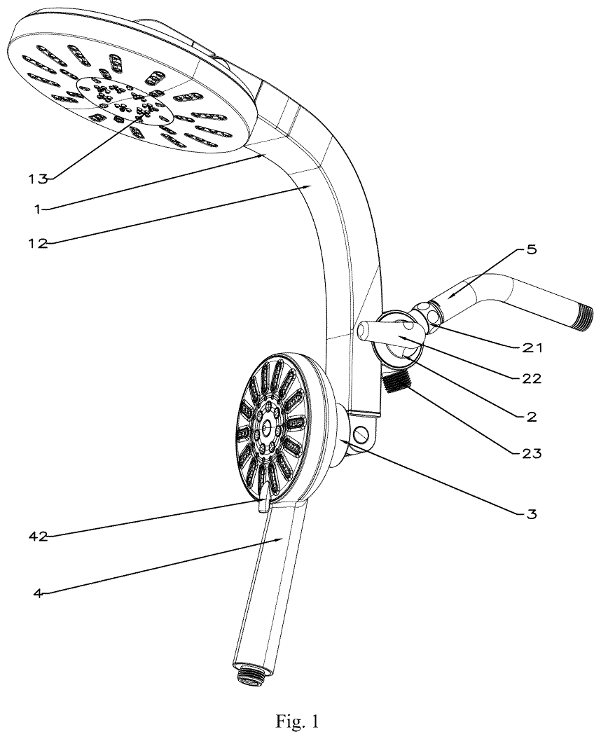

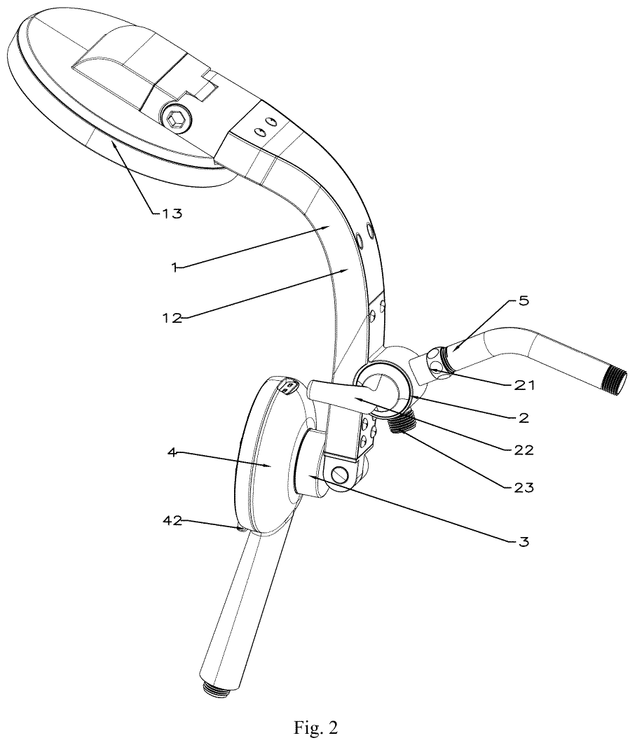

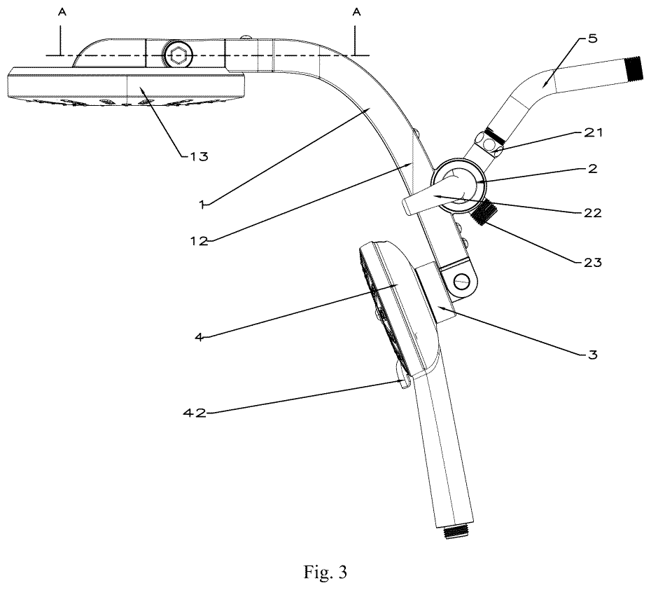

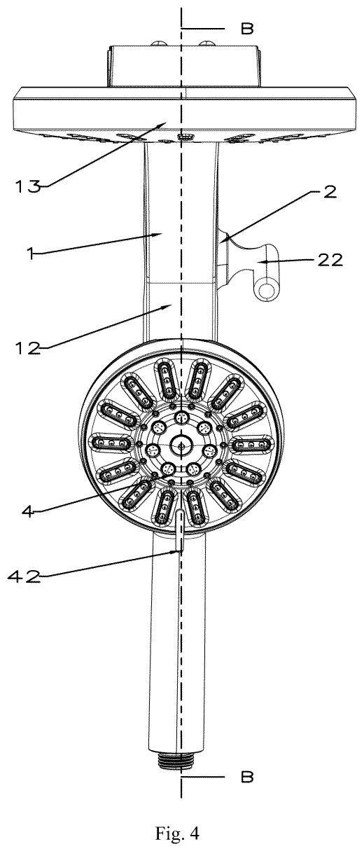

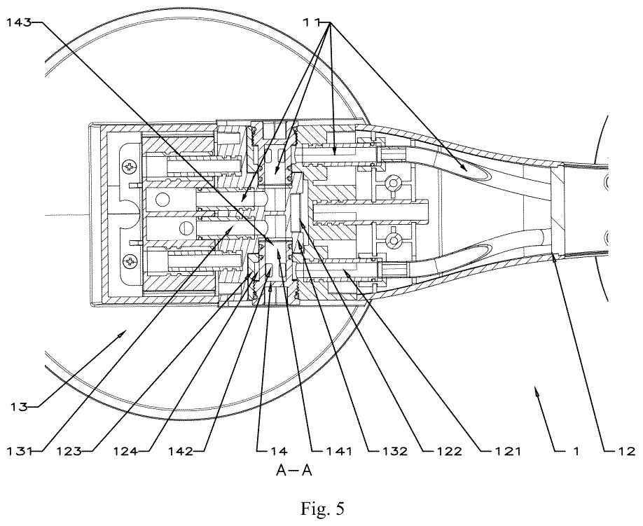

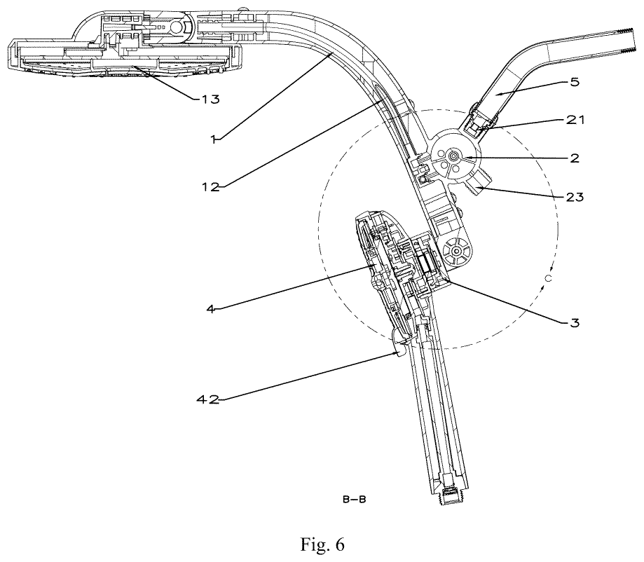

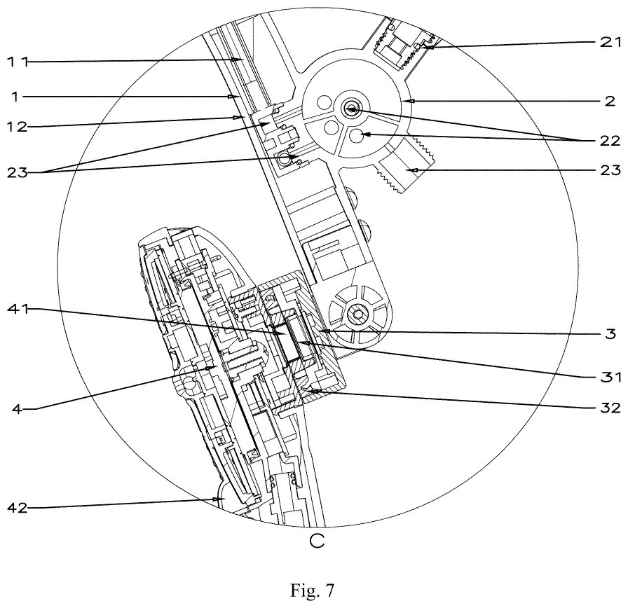

Description of reference numerals in FIGS. 1 to 7: top shower 1, top shower water inlet passage 11, mounting handle 12, fixed section 121, mating slot 122, mating lug 123, shaft hole 124, water outlet head 13, pivotal section 131, mating plug 132, pivotal shaft 14, connecting section 141, water inlet 142, water outlet 143, fixed valve 2, water inlet connector 21, switching assembly 22, water outlet passage 23, hand shower holder 3, magnetic slot 31, buffer rubber ring 32, hand shower 4, magnetic protrusion 41, switch 42, pre-embedded pipe 5.

### DETAILED DESCRIPTION OF THE EMBODIMENTS

In order to make the technical problems to be solved by the present disclosure, technical solutions and beneficial effects of the present disclosure clearer and more understandable, the present disclosure is further described in detail below in conjunction with the accompanying drawings and embodiments. It should be appreciated that the embodiments described herein are for illustration purposes only and are not intended to limit the present disclosure.

Referring to FIGS. 1 to 7, a multifunctional shower device includes a top shower 1 and a fixed valve 2.

The top shower 1 has at least two water outlet modes, and correspondingly includes at least two sets of water outlet nozzles and water inlet passages that are in communication in one-to-one correspondence.

The fixed valve 2 is provided with a water inlet connector 21, a switching assembly 22, a water outlet passage 23, and a switching handle. The water outlet passage 23 has at least three branches, including top shower 1 water outlet passages 23 and hand shower 4 water outlet passages 23 having openings obliquely downward. The water inlet connector 21 communicates with any of the water outlet passages 23 by the switching of the switching assembly 22, such that the shower device discharges water from either the top shower in any water outlet mode or from the hand shower; moreover, by selecting different switch settings as needed, the shower device can also discharge water from the top shower in different water outlet modes simultaneously, or can discharge water from both the top shower in any water outlet mode and the hand shower 4 at the same time. In this embodiment, the fixed valve 2 is provided with a mounting cavity that is in communication with the water inlet connector 21 and the water outlet passages 23. The switching assembly is mounted inside the mounting cavity, and the switching assembly is provided with a switching handle disposed on an outer peripheral of the fixed valve 2 for easy operation. In one embodiment, a water-dividing ceramic is used as the switching assembly, being simple in structure.

The top shower 1 is mounted to the fixed valve 2, and the top shower 1 water outlet passages 23 of the fixed valve 2 are in communication with the top shower water inlet passages 11 of the top shower 1 in one-to-one correspondence. The water inlet connector 21 of the fixed valve 2 is connected to a water outlet end of a pre-embedded pipe 5 on the wall. The multifunctional shower device is suspended and mounted on the wall by means of the water inlet connector 21 of the fixed valve 2, such that the entire shower device is supported by the water inlet connector 21 of the fixed valve 2.

In one embodiment, the top shower 1 includes a mounting handle 12 and a water outlet head 13. One end of the mounting handle 12 is assembled with the fixed valve 2, and the water outlet head 13 is pivotally mounted to the other end of the mounting handle 12, allowing consumers to adjust the water outlet angle of the top shower 1 according to their needs.

On the basis of the above embodiments, in order to prevent the breakage of hoses, in an embodiment, the top shower water inlet passage 11 includes a fixed section 121, a pivotal section 131, and a connecting section 141. The fixed section 121 is provided at a water outlet end of the mounting handle 12. The pivotal section 131 is provided at a pivotal mounting portion of the water outlet head 13. The connecting section 141 is provided inside a pivotal shaft 14 between the mounting handle 12 and the water outlet head 13. The pivotal shaft 14 is provided with a water inlet 142 and a water outlet 143. The connecting section 141 is always in communication with a water outlet end of the fixed section 121 by means of the water inlet 142, and the connecting section 141 is always connected to a water inlet end of the pivotal section 131 by means of the water outlet 143. Thus, the water passages between the mounting handle 12 and the water outlet head 13 are integrated with the pivotal shaft 14, avoiding the use of hoses that could affect the flexibility of pivotal movement and lead to the breakage of hoses at a pivotal position.

Further, at least one water inlet 142 is provided on the periphery of the pivotal shaft 14, and is positioned on a same circumferential line of the periphery of the pivotal shaft 14; and the water outlet 143 is provided at an end portion of the pivotal shaft 14. In addition, the top shower water inlet passage 11, the top shower 1 water outlet passage 23, and the pivotal shaft 14 each may be provided in two sets to prevent the entire structure and the water passage structure from being overly complex and to optimize the structural layout. The water outlet end of the mounting handle 12 is provided with a mating slot 122. A mating lug 123 is formed at each of two ends of the mating slot 122. A mating lug 123 is formed at each of two ends of the mating slot 122. The mating lug 123 is provided with a through shaft hole 124 in communication with the mating slot 122. The water outlet end of the fixed section 121 extends into the mating lug 13 and is in communication with the shaft hole 124. The pivotal mounting portion of the water outlet head 13 forms a mating plug 132, and the water inlet end of the pivotal section 132 forms openings at two ends of the mating plug 132. The mating plug 132 is inserted into the mating slot 122, the pivotal shaft 14 is inserted into the shaft hole 124 by means of an outer portion of the mating lug 123, and an end portion of the pivotal shaft 14 is inserted into the openings at the two ends of the mating plug 132. Thus, the mating plug 132 is pivotally mounted in the mating slot 122 by the restriction of the pivotal shaft 14.

As for the installation or assembly method between the top shower 1 and the fixed valve 2, the top shower 1 and the fixed valve 2 share a same housing, or the housings of the top shower 1 and the fixed valve 2 are fastened together by means of screws. The top shower water outlet passages 23 of the fixed valve 2 form water outlet connectors in the mounting handle 12 of the top shower 1, and are in communication with the top shower water inlet passages 11 in one-to-one correspondence by means of hoses.

In another embodiment, in order to be better used in conjunction with the hand shower 4, a hand shower holder 3 facing the user is provided at the bottom of the top shower 1. The hand shower 4 is suspended on the hand shower holder 3, and the hand shower 4 is connected to the hand shower water outlet passages 23 of the fixed valve 2 by means of hoses.

On the basis of the above embodiments, in order to enhance the convenience of fixing the hand shower 4 and improve the product quality, the hand shower holder 3 and the hand shower 4 are fixed by means of magnetic attachment. The hand shower holder 3 is provided with a magnetic slot 31 facing the user. A first magnetic member is provided at a central portion of the magnetic slot 31, and a buffer rubber ring 32 is provided on a periphery of the magnetic slot 31. A magnetic protrusion 41 is provided at the back of the hand shower 4, and a second magnetic member is provided inside or at an end portion of the magnetic protrusion 41. The hand shower 4 is inserted into the magnetic slot 31 by means of the magnetic protrusion 41, and is suspended on the hand shower holder 3 by means of the magnetic attachment between the first magnetic member and the second magnetic member. An outward end of the buffer rubber ring 32 abuts against the back of the hand shower 4. In addition, for stable attachment, a circular guide groove is provided on a periphery of the magnetic slot 31, and a circular guide protrusion is provided on a periphery of an end portion of the magnetic protrusion 41.

On the basis of the above embodiments, to enrich water outlet modes of the hand shower 4 and further enhance the water outlet functions of the shower device, the hand shower 4 is provided with a switch 42 and at least two water outlet modes, and correspondingly includes at least two sets of hand shower water outlet nozzles and hand shower water outlet passages 23 in one-to-one correspondence.

The shower device provided by the present disclosure utilizes a top shower 1 having multiple water passages and a fixed valve 2 having multiple water outlet passages 23. When in use, the fixed valve 2 can be switched according to users'needs, allowing the top shower 1 installed by means of a pre-embedded pipe to have a water outlet switching function, not only increasing water outlet options of the top shower 1, but also enhancing water outlet functions of the entire shower device. In addition, the switching control of the top shower 1 is separated from the head of the top shower 1, avoiding the problem of the switching control assembly being mounting too high and difficult to reach.

Although the above embodiments have been shown and described, it should be appreciated that the above embodiments are exemplary and are not to be construed as limitations on the present disclosure. Changes, modifications, substitutions and variations of the above embodiments by those of ordinary skill in the art all fall within the scope of protection of the present disclosure.

What is claimed is:

1. A multifunctional shower device, comprising a top shower and a fixed valve,
wherein the top shower has at least two water outlet modes, and correspondingly comprises at least two sets of top shower water outlet nozzles and top shower water inlet passages that are in communication in one-to-one correspondence;
wherein the fixed valve is provided with a water inlet connector, a switching assembly, water outlet passages, and a switching handle; the water outlet passages comprise at least three branches, comprising top shower water outlet passages and hand shower water outlet passages having openings obliquely downward, and the water inlet connector is in communication with any of the water outlet passages by the switching of the switching assembly; and the switching handle is provided outside the fixed valve, and is connected to and controls the switching assembly; and
wherein the top shower is mounted to the fixed valve, and the top shower water outlet passages of the fixed valve are in communication with the top shower water inlet passages of the top shower in one-to-one correspondence; and the water inlet connector of the fixed valve is connected to a water outlet end of a pre-embedded pipe in a wall in a butt joint mode, and the multifunctional shower device is suspended and mounted on the wall by means of the water inlet connector of the fixed valve.

2. The multifunctional shower device according to claim 1, wherein the fixed valve is provided with a mounting cavity that is in communication with the water inlet connector and the water outlet passages, and the switching assembly is mounted inside the mounting cavity.

3. The multifunctional shower device according to claim 1, wherein the top shower comprises a mounting handle and a water outlet head, one end of the mounting handle is assembled with the fixed valve, and the water outlet head is pivotally mounted to the other end of the mounting handle.

4. The multifunctional shower device according to claim 3, wherein the top shower water inlet passage comprises a fixed section, a pivotal section, and a connecting section, the fixed section is provided at a water outlet end of the mounting handle, the pivotal section is provided at a pivotal mounting portion of the water outlet head, and the connecting section is provided inside a pivotal shaft between the mounting handle and the water outlet head, and wherein the pivotal shaft is provided with a water inlet and a water outlet, the connecting section is always in communication with a water outlet end of the fixed section by means of the water inlet, and the connecting section is always in communication a water inlet end of the pivotal section by means of the water outlet.

5. The multifunctional shower device according to claim 4, wherein one of the water inlet and the water outlet is provided on the periphery of the pivotal shaft, the number of the water inlet or the water outlet is at least one, the at least one water inlet or water outlet is positioned on a same circumferential line of the periphery of the pivotal shaft, and the other of the water inlet and the water outlet is provided at an end portion of the pivotal shaft.

6. The multifunctional shower device according to claim 5, wherein the top shower water inlet passage, the top shower water outlet passage, and the pivotal shaft each are provided in two sets, a mating slot is provided at the water outlet end of the mounting handle, a mating lug is formed at each of two ends of the mating slot, the mating lug is provided with a through shaft hole in communication with the mating slot, the water outlet end of the fixed section extends into the mating lug and is in communication with the shaft hole; and the pivotal mounting portion of the water outlet head forms a mating plug, and the water inlet end of the pivotal section forms openings at two ends of the mating plug; the mating plug is inserted into the mating slot, the pivotal shaft is inserted into the shaft hole by means of an outer portion of the mating lug, and an end portion of the pivotal shaft is inserted into the openings at the two ends of the mating plug, and the mating plug is pivotally mounted in the mating slot by the restriction of the pivotal shaft.

7. The multifunctional shower device according to claim 1, wherein the top shower and the fixed valve share a same housing, or housings of the top shower and the fixed valve are fastened together by means of screws; and the top shower water outlet passages of the fixed valve form water outlet connectors in the mounting handle of the top shower, and are in communication with the top shower water inlet passages in one-to-one correspondence by means of hoses.

8. The multifunctional shower device according to claim 1, wherein a hand shower holder facing a user is provided at the bottom of the top shower, a hand shower is suspended on the hand shower holder, and the hand shower is in communication with the hand shower water outlet passages of the fixed valve by means of hoses.

9. The multifunctional shower device according to claim 8, wherein the hand shower holder and the hand shower are fixed by means of magnetic attachment, the hand shower holder is provided with a magnetic slot facing the user, a first magnetic member is provided at a central portion of the magnetic slot, and a buffer rubber ring is provided on a periphery of the magnetic slot; a magnetic protrusion is provided at the back of the hand shower, and a second magnetic member is provided inside or at an end portion of the magnetic protrusion; and the hand shower is inserted into the magnetic slot by means of the magnetic protrusion and is suspended on the hand shower holder by means of magnetic attachment between the first magnetic member and the second magnetic member, and an outward end of the buffer rubber ring abuts against the back of the hand shower.

10. The multifunctional shower device according to claim 8, wherein the hand shower is provided with a switch and has at least two water outlet modes, and correspondingly comprises at least two sets of hand shower nozzles and hand shower water outlet passages that are in communication in one-to-one correspondence.
